(19) United States
(12) Patent Application Publication
(10) Pub. No.: US 2014/0080993 A1
(43) Pub. Date: Mar. 20, 2014

(54) Process For Preparing Polymeric Fibers Comprising Thermotropic Liquid Crystalline Polymer And Carbon Nanotubes

(71) Applicant: FIBRASTIC LIMITED, Chai Wan (HK)

(72) Inventor: Willie Ka Yeung YU, Chai Wan (HK)

(73) Assignee: FIBRASTIC LIMITED, Chai Wan (HK)

(21) Appl. No.: 13/623,410

(22) Filed: Sep. 20, 2012

(51) Int. Cl. B29B 9/06; C08G 63/06; B82Y 30/00

(52) U.S. Cl. 528/193; 264/8; 977/752

(57) ABSTRACT

The invention relates to polymeric fibers and a process of preparing polymeric fibers. The process comprises the steps of synthesizing a composite of thermotropic liquid crystalline polymer (TLCP) comprising multi-walled carbon nanotubes (MWNTs), and spinning the composite to form composite fibers. Specifically, the MWNTs are incorporated at a very low concentration. It is demonstrated that the as-spun TLCP/MWNTs composite fibers demonstrated significantly enhanced mechanical properties as compared with the control TLCP fibers without MWNTs. Fibers having 0.3 wt % MWNTs (C-3) demonstrated an increase of tensile modulus and strength by 38% and 32%, respectively, when compared with the control TLCP fiber without MWNTs.

### FIELD OF THE INVENTION

The present invention relates to a process of preparing fibers of polymer composite. Specifically, the present invention relates to a process of preparing fibers of thermotropic liquid crystalline polymer/carbon nanotubes composite.

### BACKGROUND OF THE INVENTION

Main chain thermotropic liquid crystalline polymer (TLCP) has attracted extensive interest both academically and industrially since early 1970s due to their ease of processing and high mechanical and thermal properties. The most notable commercially successful high-performance TLCP fiber is Vectran™ which is prepared by using a conventional fiber spinning process. In the preparation of high performance TLCP fibers, a two-stage process is usually employed in practice. In the first stage, high orientation fibers are spun from the resins with a low molecular weight. The tensile strength of the melt spun fibers is around 1 GPa, which is limited due to the presence of skin-core and multi-domain structure. Fibers with higher tensile strength of 2-3 GPa are achievable through solid state polymerization, which is usually carried out at a temperature which is 20° C. below the melting temperature of the TLCP.

Carbon nanotubes (CNTs) are considered to be “perfect whiskers” with exceptional mechanical properties. It is generally accepted that the tensile strength and modulus of individual CNT are up to 60 GPa and 1 TPa, respectively. CNTs are also known to have extremely high resilience with ultimate strain at break greater than 5%. It is believed that incorporation of CNTs in polymer matrix may lead to ultimate fiber reinforced composite with significantly enhanced mechanical properties. However, dispersion of CNTs in polymer matrix has always been a challenging issue because the CNTs usually form strong bundles due to the van der Waals forces between adjacent tubes. Various methods have been reported to disperse CNTs in the polymer matrix, e.g., solution blending, melt blending, and in-situ polymerization. Besides, interfacial interaction between the polymer and the CNTs is also critical in terms of load transfer effect. A great deal of effort has been focused on the covalent modification of CNTs as a means to achieve optimal interfacial adhesion. In comparison, the in-situ polymerization method has advantage over the solution and melt blending methods, as high concentration of active functional groups exist in the monomer which may react with the treated CNTs to form covalent bonds.

It is an object of the present invention to provide an alternative or improved process of preparing high performance fibers of TLCP and CNTs.

### SUMMARY OF THE INVENTION

According to the present invention, there is provided a process of preparing polymeric fiber. The process includes the steps of synthesizing a composite of thermotropic liquid crystalline polymer comprising carbon nanotubes, and spinning the composite to form composite fiber.

There is also provided a polymeric fiber which is prepared in accordance with the above-mentioned process.

### BRIEF DESCRIPTION OF THE DRAWINGS

FIG. 1 is a schematic diagram showing the preparation of thermotropic liquid crystalline polymer/multi-walled carbon nanotube (TLCP/MWNT) composites in accordance with an embodiment of the present invention.

FIG. 2 shows the fourier transform infra-red (FTIR) spectra of the MWNTs as prepared by the process according to FIG. 1, with the spectrum of the MWNTs without acid treatment presented by circles, and the spectrum of the acid-treated MWNTs represented by squares, and the spectrum of the MWNTs grafted with monomers represented by diamonds.

FIG. 3 shows the Raman spectra of the MWNTs as prepared by the process according to FIG. 1, with the spectrum of the MWNTs without acid treatment presented by solid line, and the spectrum of the acid-treated MWNTs represented by dashed line.

FIG. 4(a) shows the transmission electron microscopy (TEM) of the MWNTs acid-treated at 80° C. for 30 min in accordance with the process of FIG. 1.

FIG. 4(b) shows the TEM of the MWNTs acid-treated at 90° C. for 30 min in accordance with the process of FIG. 1.

FIG. 4(c) shows the TEM of the MWNTs before acid treatment in accordance with the process of FIG. 1 FIG. 5 shows the carboxylic acid-functionalized MWNTs dispersed in acetic acid (left) and acetic anhydride (right).

FIG. 6 shows the typical stress-strain curves of the free falling TLCP/MWNTs composite prepared according to FIG. 1.

FIG. 7(a) shows the SEM of the fracture surface of the free falling TLCP without MWNTs (C-0).

FIG. 7 (b) shows the SEM of the fracture surface of the free falling TLCP/MWNTs composite with 0.1 wt % MWNTs (C-1) prepared according to FIG. 1.

FIG. 7 (c) shows the SEM of the fracture surface of the free falling TLCP/MWNTs composite with 0.3 wt % MWNTs (C-3) prepared according to FIG. 1.

FIG. 7 (d) shows the SEM of the fracture surface of the free falling TLCP/MWNTs composite with 0.5 wt % MWNTs (C-5) prepared according to FIG. 1.

FIG. 8 shows the X-ray diffraction (WXRD) of the free falling TLCP/MWNTs composites.

FIG. 9 shows the typical stress-strain curves of the C-0 and C-3 TLCP/MWNTs composite fibers.

FIG. 10 shows the WXRD of the as-spun TLCP/MWNTs composite fibers.

FIG. 11 shows the effect of concentrations of the MWNTs on the degree of crystallinity of the TLCP/MWNTs composite fibers.

FIG. 12 shows the scanning electron microscopy (SEM) of the fracture surface of the TLCP/MWNTs composite fibers at high magnifications.

FIGS. 13(a) and (b) show the TEM showing the cross-sectional view of the C-3 TLCP/MWNTs composite fibers at low magnification (a) and high magnification (b),

FIGS. 13(c) and (d) show the TEM showing the cross-sectional view of the C-5 TLCP/MWNTs composite fibers at low magnification (c) and high magnification (d).

FIG. 14 shows the polarized optical microscopy (POM) of the TLCP/MWNT composites prepared according to FIG. 1.

### DESCRIPTION OF THE PREFERRED EMBODIMENTS

According to the present invention, there is provided a process of preparing high performance fibers of a composite of thermotropic liquid crystalline polymer (TLCP) and carbon nanotubes (CNTs) (TLCP/CNTs composite). Broadly speaking, the process includes the steps of synthesizing the TLCP/CNTs composite, followed by spinning of the composite by a conventional spinning machine to form fibers. In this context, a conventional spinning machine includes but is not limited to, for example, Haake Rheomex OS PTW16 and Melt Pump OS from Thermo Scientific etc, which may comprise a twin screw extruder, a melt pump, a spinneret and a take-up apparatus. The diameter of the resulting fibers is dependent on the draw ratio of the machine, which is related to the flow speed of the melt of the composite at the exit of the spinneret and roller speed of the take-up apparatus. Preferably, the fibers are of about 10 μm to 100 μm in diameter and, more preferably, the fibers are of about 20 μm to 50 μm in diameter.

The CNTs are incorporated into the TLCP matrix at low concentration. Preferably, the CNTs are present in the composite at a concentration of about 0.1 to 2 wt %, and more preferably at about 0.1 to 0.5 wt % of the composite. The TLCP/CNTs composite can be synthesized via in-situ polymerization. Preferably, the CNTs are multi-walled carbon nanotubes (MWNTs), which consist of multiple rolled layers forming concentric tubes of grapheme. Although single-walled carbon nanotubes (SWNTs) possess even higher modulus and strength, the dispersion issue could be a great challenge. Any agglomeration of CNTs inside the fibers would cause severe stress concentration, which may exert negative effect on the mechanical properties of as-spun fiber. In one embodiment of the present invention, the MWNTs are of about 20 nm to 40 nm in diameter and of about 5 μm to 15 μm in length.

It is preferred that the carbon nanotubes be modified to bear some functional groups on the surface prior to the synthesis of the TLCP/CNTs composite, so as to improve dispersion of the CNTs in the TLCP matrix and also to assist in improving the interfacial load transfer due to the covalent bonding in between them. The functional groups can be selected from the group consisting of carboxylic acid, aryl chloride, amine, acetoxy or a mixture thereof. In one embodiment of the present invention, the MWNTs are acid-treated to provide surface carboxylic acid groups, which are capable of reacting with the monomers employed in the synthesis of thermotropic liquid crystalline polymer. Specifically, the acid-treatment can be provided by introducing the MWNTs into a mixture of concentrated nitric acid (5 M to 15.8 M) and concentrated sulphuric acid (6 M to 18.4 M) in a ratio of 1:3 v/v, followed by stirring and heating the MWNTs/acids mixture at about 80° C. to 120° C. for about 10 min to 600 min.

It is preferred that the TLCP are prepared from at least one monomer having at least one aryl group. It is also preferred that the TLCP shows nematic phase at a temperature of less than or equal to 400° C., with any temperature above 400° C. being degradative to the TLCP. The term “nematic phase” means that the TLCP molecules show no positional order but instead tends to point towards the same direction. It is further preferred that the TLCP be a thermotropic liquid crystalline polyester, and that the monomers be selected from the group consisting of 4-hydroxybenzoic acid, 6-hydroxy-2-naphthoic acid, terephthalic acid, hydroquinone, 4,4′-biphenol and a mixture thereof. In one embodiment, the monomers, 4-hydroxybenzoic acid and 6-hydroxy-2-naphthoic acid are first mixed with a catalytic amount of acetyl compound such as acetic anhydride, and the mixture is esterified at 120° C. for 1 hour to form clear solution. The acid-treated MWNTs are subsequently added in the solution, followed by ultrasonication of the mixture under nitrogen flow.

The ultrasonication may be performed for 10 min to 120 min to ensure that the MWNTs are well dispersed in the reaction mixture where the MWNTs will react with the acetoxy groups of the monomers to form covalent bondings. The covalent bonding assists in providing an efficient interfacial load transfer between the as-synthesized TLCP and the MWNTs, which minimizes stress accumulation in the TLCP matrix and consequently enhance the mechanical properties of the TLCP/MWNTs composite.

In general, polymerization of the MWNTs with the monomers can be performed under conventional polymerization conditions for polyesters which are known in the field. For example, the polymerization can be conducted at a temperature range of about 130° C. to 330° C. for about 1 hour to 5 hours, depending on the desired molecular weight of the synthesized polymer. At the end of the polymerization, a vacuum may be applied to remove any volatile by-products and to complete the polymerization.

The synthesized TLCP/MWNTs composite is then spun into fibers using a conventional spinning machine. The as-spun MWNTs-containing composite demonstrates significantly enhanced mechanical properties as compared with the control TLCP fiber which is without MWNTs. The fibers having 0.3 wt % MWNTs (C-3) show a tensile modulus and strength increase by 38% and 32%, respectively, when compared with control TLCP fiber without MWNTs. The same samples after annealing are found to demonstrate similar effect of enhancement to the tensile modulus and tensile strength by approximately 38%, and 29%, respectively. And unexpectedly, the TLCP/MWNTs composite fibers also show tremendous enhancement in mechanical properties when compared with the TLCP/MWNTs composite without further processed by spinning. Experimental data show that, for the C-3 fibers, tensile modulus has increased from 5.52 GPa to 63.4 GPA, and tensile strength has increased from 0.4 GPa to 1.1 GPa after spinning. To our knowledge, the significant improvement of mechanical properties by the incorporation of such a low, or extremely low, concentration of MWNTs to the TLCP with a further step of spinning during the preparation process is not precedently known.

It is proposed that the enhanced mechanical properties are due to a combined synergical effect of the reinforcement of the TLCP by the incorporation of MWNTs, the intrinsic alignment of TLCP chains by seeding the growth of the TLCP domain with the incorporated MWNTs, and more importantly, the induced orientation of the TLCP chains and the MWNTs by the spinning effect.

It is known in the art that the addition of nanofillers into a polymer matrix, for example, by mere mixing of CNTs into polymer, reinforces the mechanical properties of the resulting composite. Nevertheless, the nanofillers have to be present in a substantial concentration in order to provide the reinforcement. In most cases, nanofiller concentration of around 1-10 wt % is required for the composite to exhibit the enhanced properties. As a comparison, the present invention allows reinforcement with a much reduced concentration of MWNTs which is less than or equal to 0.5 wt %. Surprisingly, it is even noticed in the present invention that the TLCP/MWNTs composite fibers with MWNTs concentration of 0.5 wt % (C-5) or higher exhibit a slight reduction in the ductility than those of the C-3 fibers, which is due to an agglomeration effect of the MWNTs at an increasing concentration.

The incorporation of low concentration of nanofillers into a polymer matrix, such as, in the range of the extremely low concentration of MWNTs as embodied by the present invention, is known to negatively affect the mechanical properties of the polymer. It is due to the fact that the presence of nanofillers in low concentration in the polymer matrix would behave as “impurities” in the overall structure which stimulate stress concentration at the site of the impurities. The negative effect on the strength of a TLCP/nano-composite by the introduction of low concentration nanofillers is evidenced by further studies which showed that even with an addition of carbon nanofibers at very low concentration (i.e. 0.1 wt %), the orientation of the TLCP chains was found to be decreased, with the orientation decreased with an increasing concentration of carbon nanofibers. Orientation of the TLCP chains is known to be closely related to the mechanical properties of the TLCP. Therefore, the incorporation of nanofillers at less than 0.5 wt % is not likely to reinforce the mechanical properties of the composite, but instead making the resulting composite weaker and more brittle. On the contrary, the present invention demonstrates a process of synthesizing TLCP/MWNTs composite with a low concentration of MWNTs and the composite is further processed by spinning to form very fine fibers. It is evident that the as-synthesized TLCP/MWNTs fibers possess nature and properties which are different from or even contrary to the common expectations in the field. Unexpected results of the present invention show that the enhanced orientation of the TLCP chains and therefore the improved mechanical properties with the presence of the MWNTs in low concentration (up to 0.5 wt %) are induced by spinning. The effect of spinning in improving the mechanical properties of the composite could be attributed to pseudo-nucleation effect of the MWNTs. The abundant benzene groups in the TLCP backbone may interact with the MWNTs via π-π stacking to form a core-shell structure. The MWNTs may act as pseudo-nucleation sites for the adjacent TLCP molecules. The domain size of a TLCP molecule is of approximately a few microns, while the MWNTs are micron in scale. The domain size of the TLCP molecules could therefore be enlarged with the presence of a small amount of MWNTs. Consequently, the TLCP molecules could be more easily oriented during the extrusion and the spinning, which may improve the overall orientational order and benefit the preparation of high performance TLCP products. This explains the significant increase of mechanical properties of the TLCP/MWNT fibers, which is resulted from the enhanced orientation of the TLCP chains induced by the MWNTs during the spinning process.

The following examples are included to demonstrate the preferred embodiments of the present invention. However, it should be appreciated that modifications can be made to the specific embodiments and still capable of achieving a like or similar result without departing from the spirit and scope of the invention.

### EXAMPLES

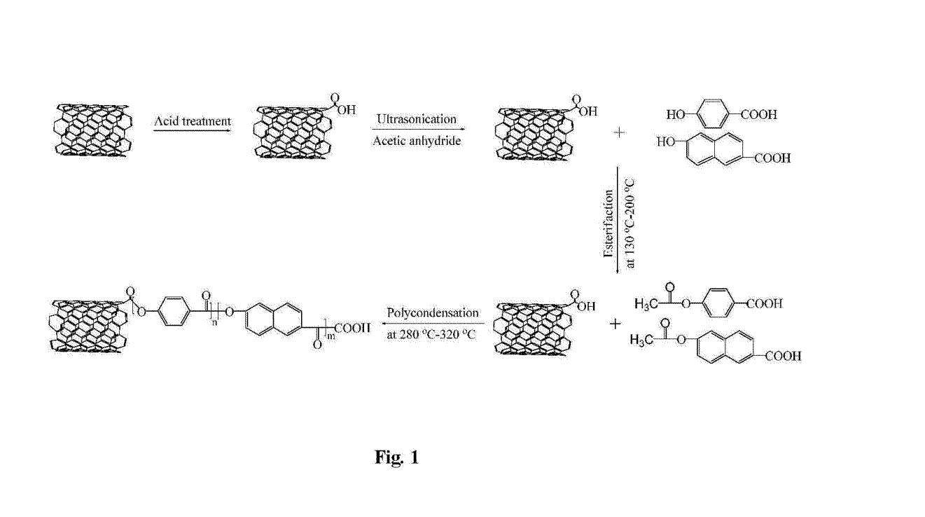

The TLCP/MWNT composites were prepared via in-situ polymerization, as depicted schematically in FIG. 1. The MWNTs were first acid treated to produce some carboxylic acid groups on the tubes. During the polymerization, these modified MWNTs were dispersed in an esterified solution of the monomers by ultrasonication. The modified MWNTs reacted with the acetoxy groups of the monomers so that covalent bonding was achieved.

### Acid Treatment of MWNT

MWNTs were added to the mixture of concentrated nitric acid

(HNO₃) (15.8 M) and concentrated sulphuric acid (H₂SO₄) (18.4 M) with a volumetric ratio of 1:3 and this mixture was stirred at 80° C. for 30 min to create carboxylic acid groups on the MWNTs surface. This mixture was diluted with excess deionized water and then vacuum filtered through 0.20 μm millipore polycarbonate membrane until a pH value of 7 of the filtrate was reached. The solid residue was dried in a vacuum oven at 120° C. for 12 hours to yield the modified MWNTs.

### Preparation of TLCP/MWNT Composites

Synthesis of Pure TLCP (C-0):

In a glove box with nitrogen (N₂), 4-hydroxybenzoic acid (HBA) (800.0 g, 5.79 mol), 6-hydroxy-2-naphthoic acid (HNA) (403.1 g, 2.14 mol) and terephthalic acid (TA) (1.5 g, 0.009 mol) were charged into 3 liter glass reactor. A catalytic amount of potassium acetate (0.06 g, 50 ppm) dissolved in 1 ml of acetic acid was added into the reactor as catalysts, followed by the addition of acetic anhydride (840.0 g, 8.23 mol) which converts the hydroxyl groups of the HBA and HNA into acetoxy groups. The reaction mixture was heated at 130° C. for 1 hour and then raised to 200° C. for another 2 hours to complete the esterification. Afterwards, the mixtures were transferred to a 2 liter stainless steel reactor. Before transferring, the reactor was subjected to 3 cycles of vacuum/N₂ purge to exclude any traces of air and moisture in the reactor. The temperature of the reactants was then raised to about 280° C. to 320° C. for the polymerization to proceed. During the polymerization, around 95% of the acetic acid was distilled off in about 3 hours. The N₂ purge was then closed and the reactor was evacuated for 2 hours. Then high pressure N₂ was introduced again into the reactor to extrude the polymer.

Ubbelhode viscometer was used to determine the inherent viscosity of the as-synthesized TLCP in 0.1 wt % pentafluorophenol at 60° C. The TLCP had an intrinsic viscosity (I.V.) of 5.37 dL/g, and a melting temperature of 281.4° C. as subjected under the heating rate of 20° C./min in a Differential Scanning calorimetry (DSC). The polymer was dried in a vacuum oven (120° C., 12 hours) and then spun into fibers. The as-spun TLCP fibers were of a diameter of about 35.7 μm, tensile modulus of about 45.8 GPa, tensile strength of 0.78 GPa, and 2.07% of elongation. Then the fibers were heat treated or annealed in a flowing stream of argon in tube furnace at 260° C. for 48 hours, the fibers demonstrated a tensile modulus of 46.3 GPa, a tensile strength of 1.68 GPa, and an elongation at break of 3.24%.

Synthesis of TLCP/0.3 wt % MWNTs Composite (C-3):

HBA (800.0 g, 5.79 mol), HNA (403.1 g, 2.14 mol) and TA (1.5 g, 0.009 mol) were charged into 3 liter glass reactor. A catalytic amount of potassium acetate (0.06 g, 50 ppm) in 1 mL acetic acid was added to the mixture. In another flask, 3.6 g acid treated MWNTs was added which was followed by the addition of acetic anhydride (840.0 g, 8.23 mol). Ultrasonication by means of a sonication tip was used to disperse the MWNT in the MWNT/acetic anhydride mixture for 15 min. Thereafter, the MWNT suspension was poured into the flask containing the monomers under N₂ protection. The batch was heated at 130° C. for 1 hour and the temperature was raised to 200° C. for another 2 hours to complete the esterification. A polymerization process similar to the synthesis of the pure TLCP (C-0) as described above was subsequently applied to prepare the TLCP/MWNTs composites which contain 0.3 wt % of MWNTs. The C-3 composite exhibits an inherent viscosity of 5.21 dL/g in pentafluorophenol at 60° C. as measured by a Ubbelhode viscometer, and a melting temperature of 281.2° C. as measured by the DSC. The composite was then spun into fibers. The as-spun TLCP/MWNTs composite fibers were of a diameter of about 29 μm, tensile modulus of about 63.4 GPa, tensile strength of 1.10 GPa, and 2.19% of elongation. The C-3 fibers were further annealed in a flowing stream of argon in tube furnace at 260° C. for 48 hours. The annealed fibers demonstrated a tensile modulus of 64.1 GPa, a tensile strength of 2.16 GPa, and an elongation at break of 3.27%.

A similar procedure was also applied to synthesize TLCP/MWNTs composites with 0.1 wt % (C-0) and 0.5 wt % (C-5). The inherent viscosity of the C-1 and C-5 composites as measured in pentafluorophenol at 60° C. is 5.29 dL/g and 5.12 dL/g, respectively. The as-spun TLCP/MWNTs composite fibers were of a diameter of about 36.3 μm and 29.3 μm, respectively, tensile modulus of about 51.9 GPa and 62.6 GPa, respectively, tensile strength of 0.95 GPa and 1.05 GPa, respectively, and 2.26% and 2.06% of elongation at break, respectively.

### Preparation of TLCP/MWNTs Composite Fibers

TLCP/MWNTs composite was first extruded by a Göttfert capillary rheometer capable of maintaining a stable flow rate of the polymer melt. The piston diameter, the velocity, and the flow rate were set to be 12 mm, 0.5 mm/s and 3.39 ml/min, respectively. The composite was first heated at 300° C. for 20 min, followed by extruding the composite through a die with a length of 30 mm and a diameter of 1.0 mm. The as-extruded composite fiber in its molten state solidified upon cooling under ambient atmosphere.

The composite was dried in the vacuum oven at 120° C. for 12 hours, and then spun into continuous fine composite fibers. The fibers were prepared by a conventional spinning machine, which comprises a twin screw extruder, a metering pump, a spinneret with a diameter of 0.2 mm, a godet and a take-up roller. The spinning was performed under a temperature of 300° C. with a flow rate of 0.3 ml/min and a take-up speed of 400 m/min. More specifically, the fibers were spun in a 10-holes spinneret with a diameter of 200 μm, connected with a Hakke twin screw extruder. The temperature of the heating zone, from the hopper to the spinneret, was set to 230° C., 290° C., 295° C., 300° C., 295° C., 290° C., respectively. The fibers as-spun were of a diameter of approximately 30 μm.

### Characterization of MWNTs

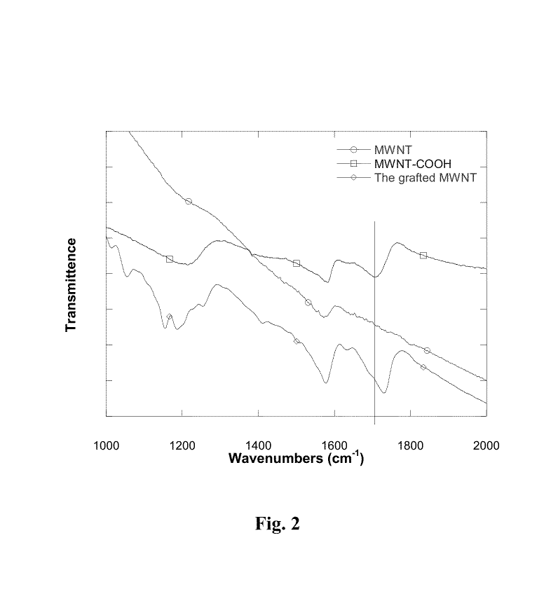

FTIR spectra of the MWNTs before (without) and after (with) surface modification by acid-treatment are shown in FIG. 2. As compared with the MWNTs before modification, spectrum of the modified MWNTs shows two characteristic peaks at 1200 cm⁻¹ and 1720 cm⁻¹, which should be ascribed to the C—O and C═O stretching vibrations of the carboxylic acid groups. This result shows that the carboxylic acid groups on the MWNTs were successfully produced by the acid treatment. The MWNTs grafted with the monomers shows that the characteristic peak of —C═O stretching has shifted to 1732 cm⁻¹ from 1708 cm⁻¹ of the acid treated MWNTs, indicating that the carboxylic acid groups have been converted to ester groups. In addition, the peak of —C—O stretching at 1200 cm⁻¹ showed multiple peaks which may serve as an evidence that the carboxylic acid groups on the MWNTs surface have not only reacted with the acetoxy groups of HBA, but also with those of HNA. The result confirms the formation of covalent bondings between the TLCP and the MWNTs.

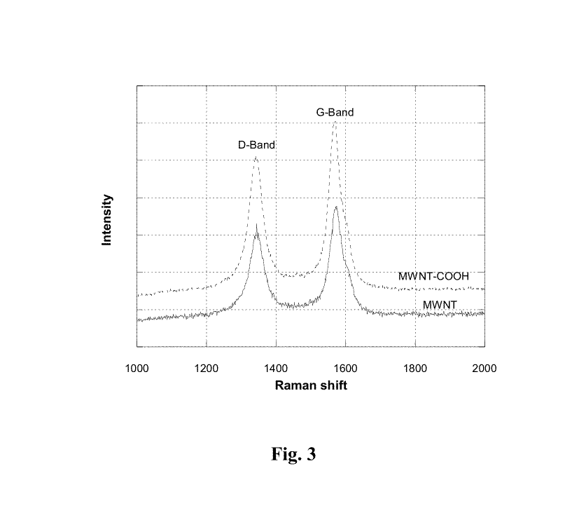

Raman spectra of the MWNTs before (without) and after (with) acid-treatment are also shown in FIG. 3. The characteristic peaks at 1320 cm⁻¹ and 1560 cm⁻¹ were termed as D-band and G-band, respectively. The G-band was related to the structural intensity of the sp²-hybridized carbon atoms of the carbon nanotubes, while the D-band was related to the disorder graphite structure resulting from the defects in the carbon nanotubes and their ends. The ratio of the intensity of the D-band (I_{D}) and the G-band (I_{G}), I_{D}/I_{G}, reflects the structural change of the carbon nanotubes. It is shown that the value of I_{D}/I_{G} increases from 0.78 to 0.83 after the acid treatment, which indicates that the treatment has not imposed appreciable changes in the graphite structure of the MWNTs.

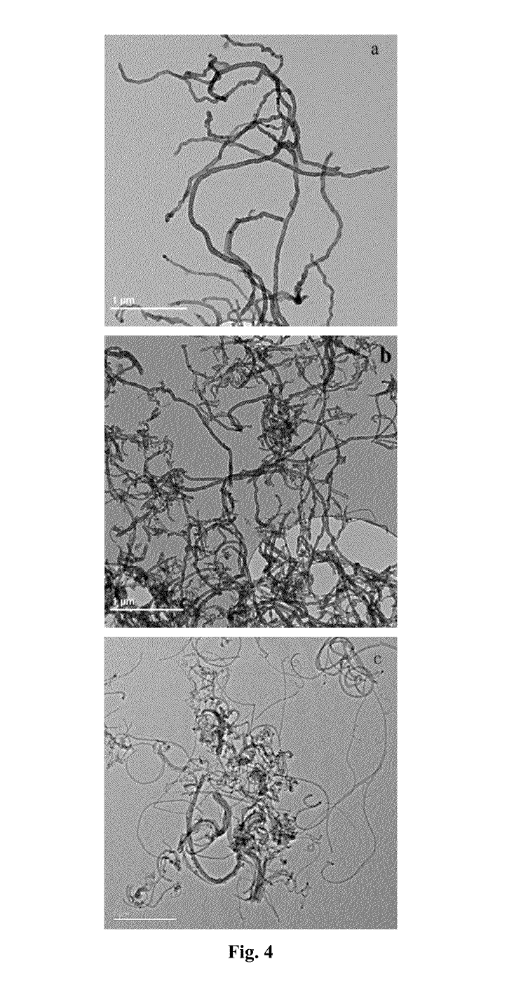

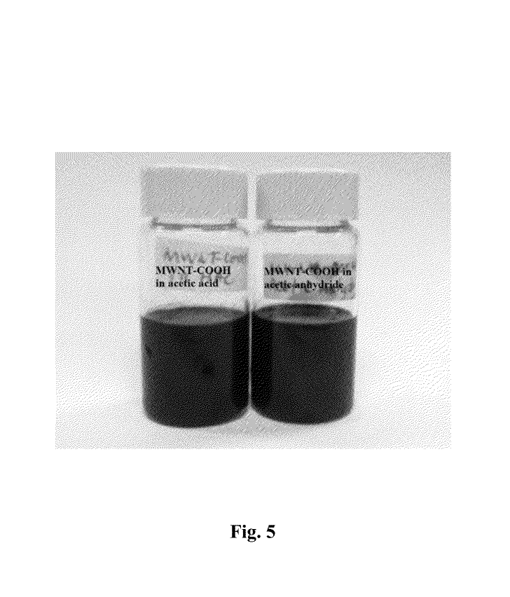

It is known that acid treatment may cleave the carbon nanotubes at high temperature. As evidenced by the Transmission Electron Microscopy (TEM) as shown in FIGS. 4(a) and 4(b), the length of the acid treated MWNTs did not change significantly after being treated with acid at 80° C. for 30 min, whereas they became much shorter after being treated at 90° C. for 30 min, and that the shortening of the MWNTs would adversely affect the reinforcement of the composite. In addition, the TEM also shows that the acid treated MWNTs exhibit a loosely entangled organization when compared with the agglomerated structure of the MWNTs before acid treatment (see FIG. 4(c)), which implies that the acid treated MWNTs can be much easily dispersed in the TLCP matrix.

FIG. 5 shows the modified MWNT dispersion in acetic acid and acetic anhydride which are used as solvents during the polymerization. This is to ensure that no agglomeration of the MWNTs occurs in the TLCP matrix during the polymerization.

### Characterization of TLCP/MWNTs Composite Fibers

Table 1 below shows the average mechanical properties of the free falling composites from the capillary rheometer.

TABLE 1
Effect of concentrations of the MWNTs on the mechanical
properties of the free falling TLCP/MWNTs composite.

| | Diameter, | Modulus, | Strength, | | Toughness,P10 |
|---|---|---|---|---|---|
| Sample | mm | GPa | GPa | Elongation, % | MPa |
| C-0 | 0.62 ± 0.01 | 3.40 ± 0.06 | 0.17 ± 0.01 | 14.04 ± 0.15 | 15.2 ± 0.6 |
| C-1 | 0.57 ± 0.01 | 3.81 ± 0.04 | 0.31 ± 0.01 | 14.96 ± 0.12 | 29.8 ± 0.8 |
| C-3 | 0.55 ± 0.01 | 5.52 ± 0.09 | 0.40 ± 0.01 | 15.17 ± 0.24 | 35.7 ± 0.9 |
| C-5 | 0.56 ± 0.01 | 5.68 ± 0.07 | 0.41 ± 0.02 | 14.85 ± 0.18 | 36.2 ± 1.2 |

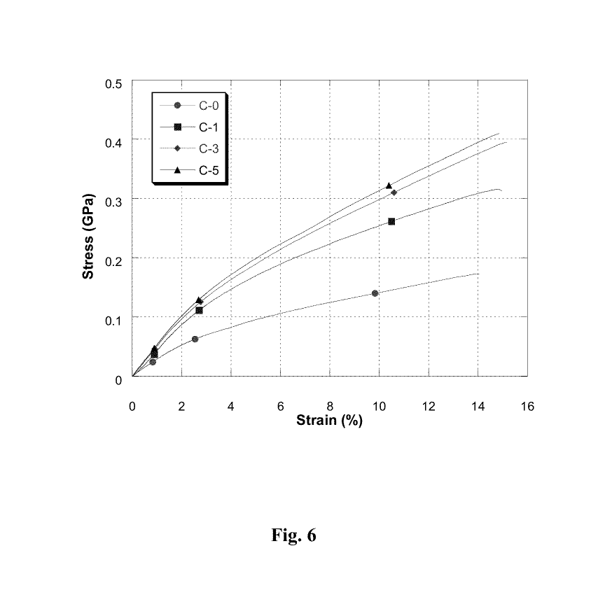

Table 1 shows the tensile properties of the TLCP/MWNTs composite extrudates as measured at room temperature, with the corresponding typical stress strain curves depicted in FIG. 6. The tensile modulus, strength and elongation to break of the C-3 extrudate were found to be higher than those of C-0 by approximately 62%, 135%, and 15%, respectively. Energies to fracture, as measured by the area under the stress-strain curve for C-0 and C-3 were 15.2 and 35.7 MPa, respectively, which demonstrated a static toughness increase of 135% for C-3 over that of C-0. It is noted that, as compared with the C-3 samples, the tensile modulus and strength of C-5 were slightly higher, but the elongation to break has decreased from 15.17% to 14.85%, which may be due to agglomeration of the MWNTs at an increased concentration.

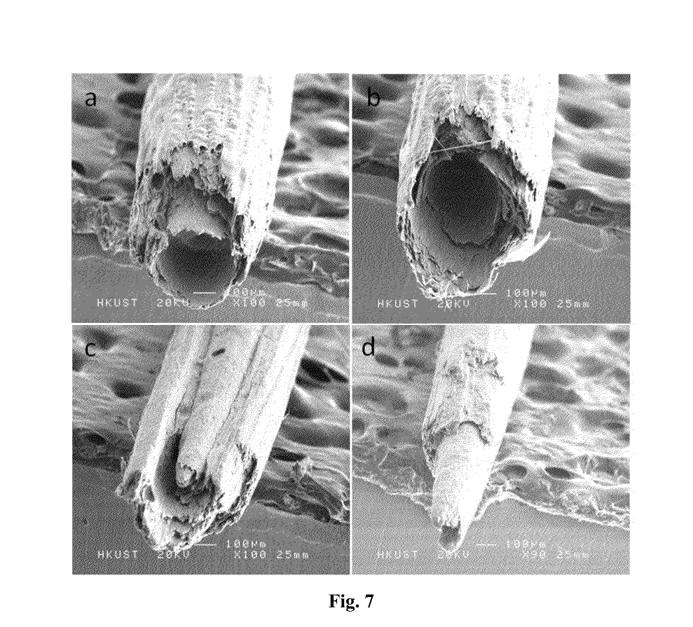

SEM has been conducted to study the fracture surfaces of the TLCP/MWNTs composite extrudates which were fractured during a tensile test. The SEM micrographs of the overall failure response are depicted in FIG. 7. With reference to FIG. 7, micrographs (a) and (b) show the fracture surfaces of the C-0 and C-1 extrudates, respectively. The fractures were found to demonstrate a brittle failure, and the fracture surfaces revealed a distinct core shell structure with a hollow core in the center of the extrudates. On the other hand, fracture surfaces of the C-3 and C-5 extrudates which are shown in micrographs (c) and (d), respectively, demonstrated a ductile failure, with the fracture surfaces exhibiting a spiral failure structure showing propagating layers towards the center of the extrudates.

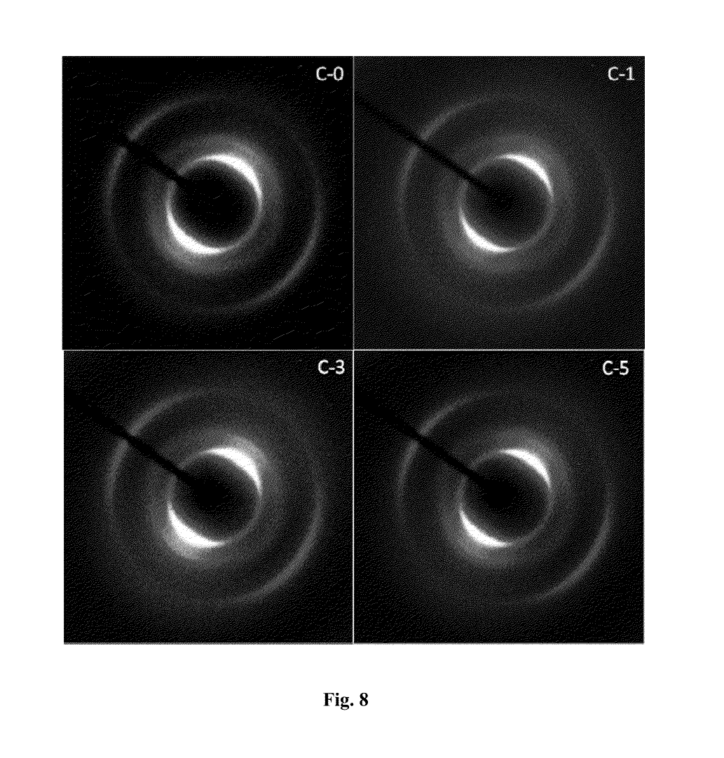

A further study on the orientation of the TLCP chains and the MWNTs of the TLCP/MWNTs composite obtained from the capillary rheometer was carried out by X-ray diffraction (WXRD) as shown in FIG. 8. It shows in all of the results that two diffused maxima were located in the equator, which are the characteristic of nematic structure in which polymer chains are oriented along the extrusion direction. The arcing of the fibers became shorter with increasing MWNTs concentration, which indicates that the MWNTs were capable of improving the orientation of TLCP chains during the extrusion process.

Table 2 below shows the mechanical properties of the as-spun TLCP/MWNTs composite fibers.

TABLE 2
Effect of concentrations of the MWNTs on the mechanical
properties of the as-spun TLCP/MWNTs composite fibers

| | | | | Elongation, |
|---|---|---|---|---|
| Sample | Diameter, μm | Modulus, GPa | Strength, GPa | % |
| C-0 | 35.7 ± 2.1 | 45.8 ± 5.6 | 0.78 ± 0.10 | 2.07 ± 0.20 |
| C-1 | 36.3 ± 4.2 | 51.9 ± 9.0 | 0.95 ± 0.13 | 2.26 ± 0.10 |
| C-3 | 29.0 ± 1.4 | 63.4 ± 4.8 | 1.10 ± 0.10 | 2.19 ± 0.14 |
| C-5 | 29.3 ± 2.1 | 62.6 ± 6.1 | 1.05 ± 0.08 | 2.06 ± 0.15 |

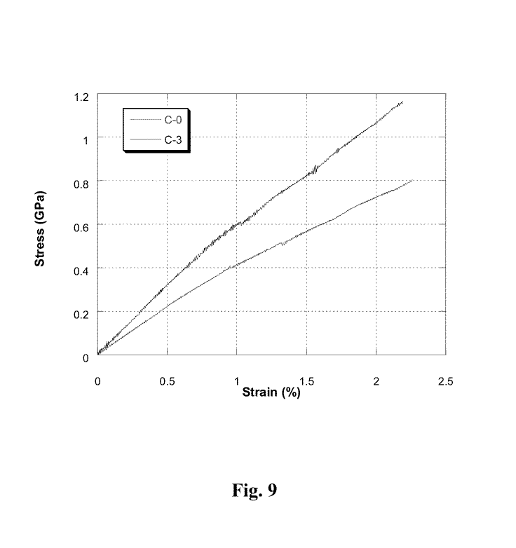

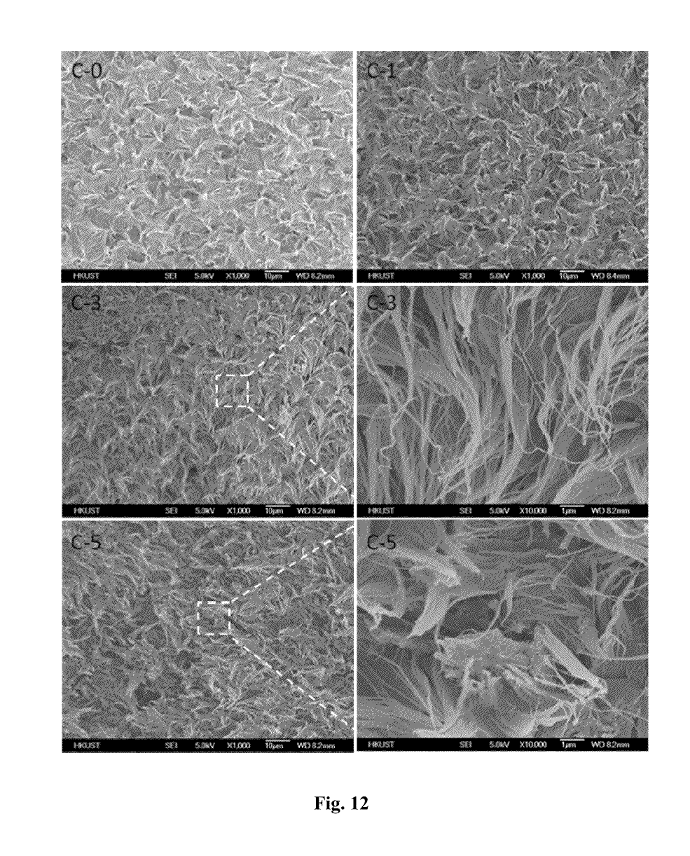

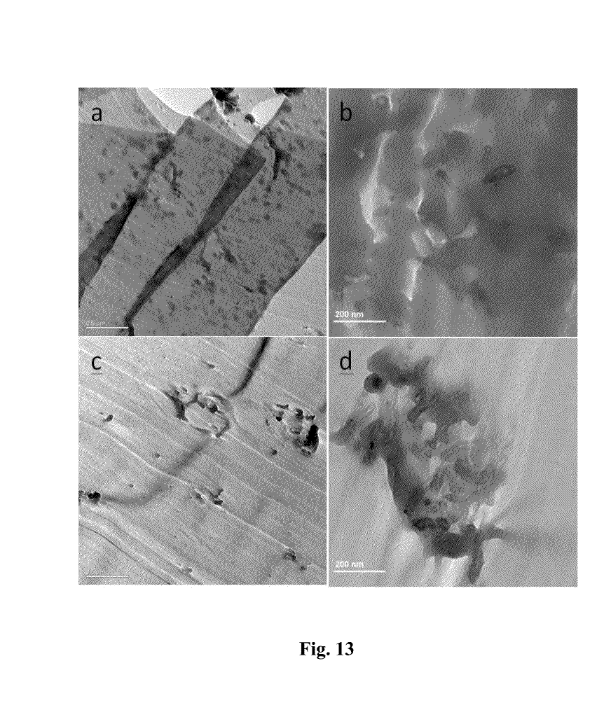

Typical stress-strain curves of the as-spun TLCP/MWNTs composite fibers are shown in FIG. 9 and the results are summarized in Table 2. The tensile modulus and strength of the C-3 fibers are higher than those of the C-0 fibers by approximately 38% and 32%, respectively. However, at the highest MWNT concentration, the C-5 fibers show lower values of tensile modulus and strength when compared with those of the C-3 fibers, which may be attributed to the large clusters as shown in the following SEM (FIG. 12) and TEM (FIG. 13) images.

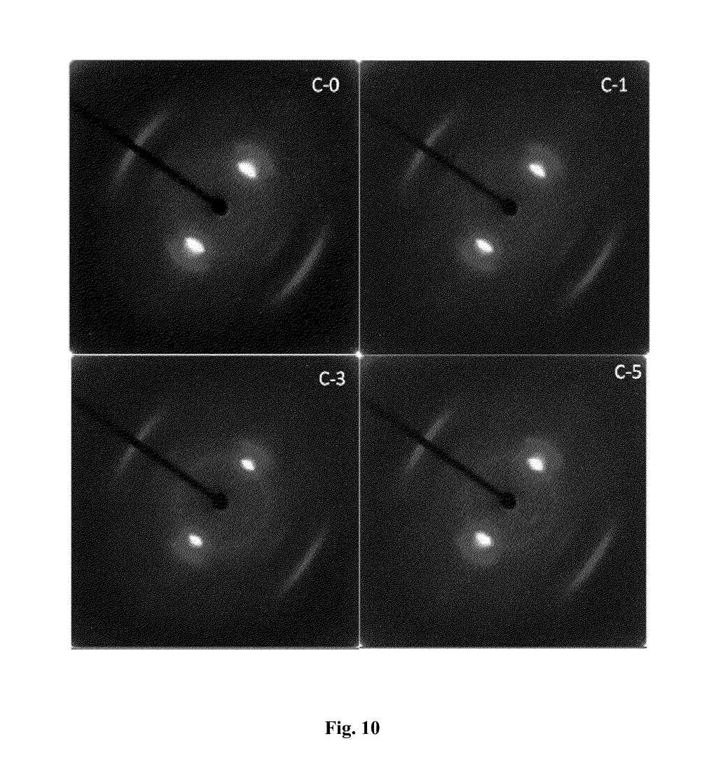

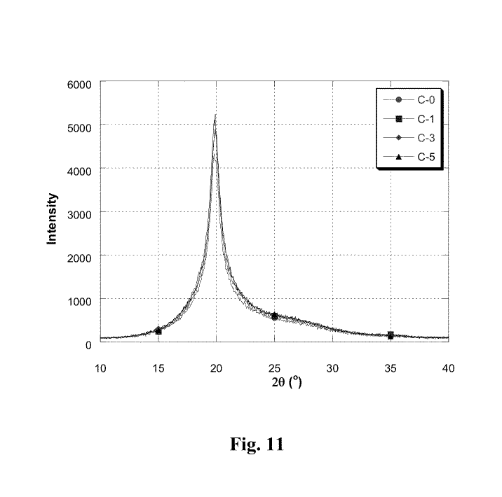

The WXRD patterns as shown in FIG. 10 demonstrate an oriented structure of the as-spun fibers. It appears in all of the results that two diffused maxima were located in the equator, which are the characteristic of nematic structure in which polymer chains are oriented along the extrusion direction. The arcing of the fibers becomes shorter with increasing MWNTs concentration, which indicates that the MWNTs are capable of improving the orientation of TLCP chains during the extrusion process. As compared with the WXRD patterns of the un-spun fibers as shown in FIG. 8, the arcing became much narrower which implies that very highly oriented structure were present in the fibers. Therefore, it is concluded that the MWNTs improved the orientation of TLCP chains during the spinning process. Besides, as shown in the graph of FIG. 11, the as-spun fibers containing 0.3 wt. % MWNTs exhibit an increase in crystallinity from 22.7% to 25.4 (Y0 when compared with the C-0 fibers. This could be due to the easy packing of the adjacent TLCP chains from the highly orientated structure of the as-spun fibers.

The homogeneous dispersion of the MWNTs in the polymer matrix is one of the most important factors in achieving mechanical strength reinforcement because inhomogeneities would lead to structural defects where stress concentration occurs so that the fibers would be easily liable to breakage. Cross-section of the TLCP/MWNTs composites was prepared by cutting the fibers in liquid nitrogen to give the fractured surface, and SEM images of the fractured surface are illustrated in FIG. 12. Highly fibrillar surfaces were observed and the morphology of the C-1 and C-3 fibers is essentially identical to that of the control fiber (C-0). The results suggest a good level of dispersion of the MWNTs within the TLCP matrix. In addition, the density and length of the fibrils in the C-3 fibers are obviously higher than those of the C-0 fibers. It is generally observed that the strength of the fibers correlates with the fibrillarity of the fractured surface and the length of the fibers being pulled out. On the other hand, in the high resolution SEM image of the C-5 fibers as shown at the bottom right hand corner of FIG. 12, it is noticeable that a number of agglomerations exist, which may lead to the semi-brittle fracture with only limited plastic deformation. The existence of agglomerations can be further evidenced by the TEM images of the C-3 and C-5 fibers as shown in FIG. 13. It can be seen that the aggregates of MWNTs are clearly visible in the C-5 fibers while the dispersion of MWNTs in the C-3 fibers is relatively uniform that even the individual tubes can be located.

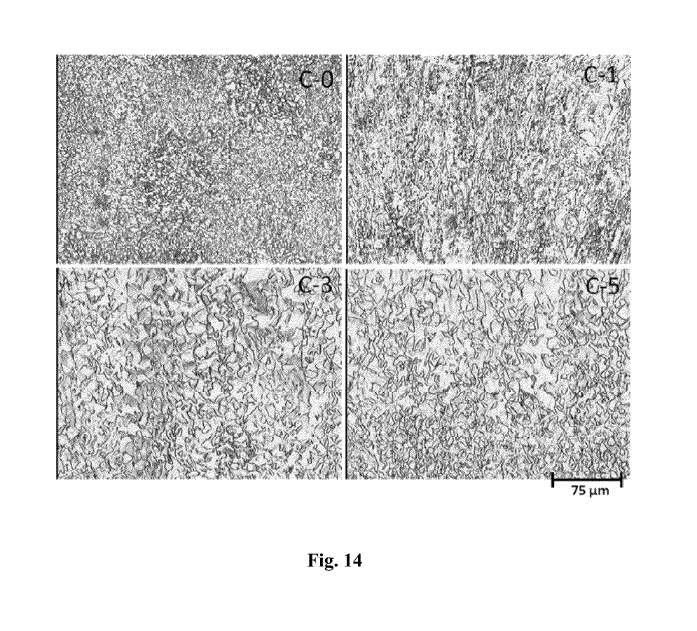

Polarized Optical Microscope (POM) was used to investigate the liquid crystal phase of the TLCP/MWNTs composite in the nematic state. The TLCP resin was placed in between two quartz plates and the temperature of the plate was first increased to 320° C. and was maintained for 10 min to ensure complete melting. Then the temperature was decreased to 300° C. because high temperature would lead to post-polymerization and possible degradation. The gap of the plates was set as 10 μm and shear of 1 s⁻¹ was exerted for 30 min and followed by relaxation for another 2 h. As shown in FIG. 14, under a crossed polarizer of the POM, threaded line textures were observed, which is a characteristic of the nematic phase of liquid crystalline polymers. The TLCP composes of multi-domains structure and the threaded lines were ascribed to the boundary of the adjacent domains. Besides, it is shown that density of the threaded lines decreased with increasing concentration of MWNTs. It could be explained by the assumption that, when the TLCP chains are physically or chemically grafted on the surface of the MWNTs, under shear deformation the MWNTs exert an anchoring effect on the TLCP chains so that the TLCP chains can be more uniformly orientated in the presence of the MWNTs, thus reducing structural defects of the composite when compared with the control sample without MWNTs.

It should be understood that certain features of the invention which are, for brevity, described here in the context of a single embodiment, may also be provided separately or in any suitable subcombination.

1. A process of preparing polymeric fiber, the process comprising the steps of:
a. synthesizing a composite of thermotropic liquid crystalline polymer comprising carbon nanotubes, and
b. spinning the composite to form composite fiber.

2. The process according to claim 1, wherein the composite is synthesized via in-situ polymerization.

3. The process according to claim 1, wherein the carbon nanotubes are present in the composite at a concentration of about 0.1 to 2 wt %.

4. The process according to claim 3, wherein the carbon nanotubes are present in the composite at a concentration of about 0.1 to 0.5 wt %.

5. The process according to claim 1, wherein the thermotropic liquid crystalline polymer is prepared from at least one monomer having at least one aryl group.

6. The process according to claim 1, wherein the thermotropic liquid crystalline polymer shows nematic phase at a temperature of less than or equal to 400° C.

7. The process according to claim 1, wherein the spinning step is performed by using a conventional spinning machine.

8. The process according to claim 1, wherein the carbon nanotubes are multi-walled carbon nanotubes.

9. The process according to claim 1, wherein the carbon nanotubes are of about 20 nm to 40 nm in diameter.

10. The process according to claim 1, wherein the polymeric fiber is of about 10 μm to 100 μm in diameter.

11. The process according to claim 10, wherein the polymeric fiber is of about 20 μm to 50 μm in diameter.

12. The process according to claim 1 further comprising a step, prior to the synthesizing step, of acid-treating the carbon nanotubes to provide surface functional groups at the carbon nanotubes.

13. The process according to claim 12, wherein the acid-treating step comprises:
c. introducing the carbon nanotubes into a mixture of nitric acid and sulphuric acid in a ratio of 1:3 v/v to form a carbon nanotubes/acids mixture, and
d. stirring the carbon nanotubes/acids mixture at about 80 to 120° C. for about 10 to 600 min.

14. The process according to claim 12, wherein the surface functional groups are selected from the group consisting of carboxylic acid, aryl chloride, amine, acetoxy and a mixture thereof.

15. The process according to claim 1, wherein the synthesizing step comprises:
e. combining at least one monomer and the carbon nanotubes to form a polymerization mixture, and
f. heating the polymerization mixture at a temperature from about 130 to 330° C. for about 1 to 5 hours.

16. The process according to claim 15, wherein the polymerization mixture comprises at least one acetyl compound.

17. The process according to claim 1, wherein the synthesizing step further comprises an ultrasonicating step carried out for a duration of about 10 min to 120 min to disperse the carbon nanotubes.

18. The process according to claim 15, wherein the at least one monomer comprises at least one aryl group.

19. The process according to claim 18, wherein the at least one monomer is selected from the group consisting of 4-hydroxybenzoic acid, 6-hydroxy-2-naphthoic acid, terephthalic acid, hydroquinone, 4,4′-biphenol and a mixture thereof.

20. A polymeric fiber prepared in accordance with the process of claim 1.
